(19) United States
(12) Patent Application Publication
(10) Pub. No.: US 2009/0238350 A1
(43) Pub. Date: Sep. 24, 2009

(54) COMMUNICATION SYSTEM FOR DETERMINING COMMUNICATION RELAY DESTINATION, APPARATUS FOR NOTIFYING RELAY DESTINATION INFORMATION, AND IP PHONE TERMINAL

(76) Inventors: Naoki ESAKA, Kanagawa (JP); Yoshimichi Tanizawa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/403,872

(22) Filed: Mar. 13, 2009

(30) Foreign Application Priority Data
Mar. 21, 2008 (JP) 2008-073410

(51) Int. Cl. H04M 11/00; H04L 12/66; H04M 15/06

(52) U.S. Cl. 379/93.02; 370/352; 379/142.05

(57) ABSTRACT

A receiving unit receives state information including operational state of an IP phone terminal, user ID, and destination ID, and stores it in a state storage unit. An obtaining unit obtains state information including a user ID included in received state information from the state storage unit. A determining unit determines an order for selecting a second destination ID as a relay destination of a communication for a first destination ID based on the operational state. A generating unit generates order information indicating a selection of the second destination ID in a determined order. A notifying unit notifies the order information to a server device.

### CROSS-REFERENCE TO RELATED APPLICATIONS

This application is based upon and claims the benefit of priority from the prior Japanese Patent Application No. 2008-073410, filed on Mar. 21, 2008; the entire contents of which are incorporated herein by reference.

### BACKGROUND OF THE INVENTION

1. Field of the Invention

The present invention relates to a communication system that determines a relay destination of a communication associated with an Internet protocol (IP) phone, an apparatus that notifies of information about the relay destination of a communication associated with the IP phone, and an IP phone terminal.

2. Description of the Related Art

Recently, an IP phone system utilizing a Voice over Internet Protocol (VoIP) has been widely and increasingly introduced into businesses. A phone terminal on which software running on a personal computer (PC) is mounted (hereinafter, “softphone”), as well as a fixed phone terminal similar to the existing telephone set are introduced as IP phone terminals. The softphone has advantages of easy interaction between software and enhanced convenience for a user who uses the PC.

An identifier corresponding to a phone number is assigned to the IP phone terminal. In operation, a user identifier for identifying a user is not always assigned as the identifier corresponding to the phone number. For example, when one fixed telephone set is installed in each area including plural desks in a company and these fixed telephone sets are replaced with IP phone terminals, this implies that plural users share one IP phone terminal. Accordingly, a phone number of the IP phone terminal cannot be assigned to each user.

Conversely, when one user owns plural PCs, the user may sometimes start plural softphones. That is, in some cases, the users and the telephones need to be managed in a one-to-many relationship. In such cases, it is necessary to properly determine which one among phone terminals owned by a user a call to the user is issued to.

JP-A 2007-88822 (KOKAI) proposes a technique that enables to transfer a call to a transfer destination of highest priority according to priorities of transfer destinations previously set for each client. JP-A 2006-157111 (KOKAI) proposes a technique that enables to display, on a communication terminal of an originating user, presence information of plural communication means that can be used by a receiving user, with the order of priority attached, and allows the originating user to select optimum communication means.

The softphone is convenient because it can be used on a PC; however, a failure can occur in the original telephone function of the softphone due to the behavior of the PC. For example, when a process that applies a high load on a central processing unit (CPU) is executed on the PC, a real-time speech processing or video processing for realizing the IP phone function can be disturbed. In the case of a softphone that operates on a portable PC, the PC can be brought into a suspended state or disconnected from a network because the user is in motion, and it is undesirable that the PC in such conditions be selected as a transfer destination. The PC is not constantly powered on to operate as the IP phone terminal, and thus it is also undesirable that the PC in such a condition be selected as a transfer destination.

When merely the processing load is high, the terminal can transfer a call to another telephone terminal at its discretion. However, a problem such that telephone terminals to which the call can be transferred need to be previously set, or that the transfer process becomes useless when the processing load is also high in the transfer destination can occur. Further, when the transfer destination is powered off, suspended, or disconnected from a network, the destination cannot even make a response. These problems occur particularly when the IP phone terminal is realized by the softphone.

In the method described in JP-A 2007-88822 (KOKAI), priority of transfer of each type of telephones including a mobile phone, a fixed phone, and a softphone is set with respect to each client, and a transfer destination terminal is selected according to the priorities. However, the transfer destination cannot be determined dynamically according to operational states of terminals such as whether a transfer destination terminal is powered on.

In the method described in JP-A 2006-157111 (KOKAI), the order of priorities according to the presence information of the user is displayed, so that the user can select a desired phone terminal as a receiving destination. However, the operational states of the terminals cannot be obtained only from the presence information of the user. Therefore, as described above, a failure can occur in the original function of the telephone due to influences such as the processing load of the terminal.

### SUMMARY OF THE INVENTION

According to one aspect of the present invention, there is provided a communication system in which a plurality of Internet-protocol phone terminals, an authenticating apparatus that authenticates users of the Internet-protocol phone terminals, and a server device that relays a communication between the Internet-protocol phone terminals are connected with one another via a network. Each of the Internet-protocol phone terminals includes a monitoring unit that monitors operational state of the Internet-protocol phone terminal, and a state notifying unit that notifies state information to the authenticating apparatus, the state information including the operational state, a user identification for identifying a user authenticated by the authenticating apparatus, and a destination identification for specifying the Internet-protocol phone terminal as a communication destination, which are related to each other. The authenticating apparatus includes a state receiving unit that receives the state information from the Internet-protocol phone terminal, a state storage unit that stores therein the state information, an authenticating unit that authenticates the users, a state obtaining unit that obtains the state information including a user identification same as a user identification included in received state information from the state storage unit, an order determining unit that determines, when a plurality of pieces of state information is obtained, an order for selecting a second destination identification included in the state information as a destination identification to be used for a relay destination of a communication addressed to a first destination identification included in the state information, based on the operational state included in each of the pieces of state information, a generating unit that generates order information indicating a selection of the second destination identification in the order determined by the order determining unit, and an information notifying unit that notifies the order information to the server device. The server device includes an information receiving unit that receives the order information from the authenticating apparatus, and a relay-destination selecting unit that selects the second destination identification based on received order information.

Furthermore, according to another aspect of the present invention, there is provided an authenticating apparatus configured to be connected to a plurality of Internet-protocol phone terminals and a server device that relays a communication between the Internet-protocol phone terminals via a network. The authenticating apparatus includes a state receiving unit that receives state information from the Internet-protocol phone terminals, the state information including the operational state, a user identification for identifying a user authenticated by the authenticating apparatus, and a destination identification for specifying the Internet-protocol phone terminal as a communication destination, which are related to each other; a state storage unit that stores therein state information; an authenticating unit that authenticates users of the Internet-protocol phone terminals; a state obtaining unit that obtains the state information including a user identification same as a user identification included in received state information from the state storage unit; an order determining unit that determines, when a plurality of pieces of state information is obtained, an order for selecting a second destination identification included in the state information as a destination identification to be used for a relay destination of a communication addressed to a first destination identification included in the state information, based on the operational state included in each of the pieces of state information; a generating unit that generates order information indicating a selection of the second destination identification in the order determined by the order determining unit; and an information notifying unit that notifies the order information to the server device.

Moreover, according to still another aspect of the present invention, there is provided an Internet-protocol phone terminal configured to be connected to an authenticating apparatus that authenticates a user of the Internet-protocol phone terminal via a network. The Internet-protocol phone terminal includes a monitoring unit that monitors operational state of the Internet-protocol phone terminal; and a state notifying unit that notifies the authenticating apparatus of state information in which the operational state, a user identification for identifying a user authenticated by the authenticating apparatus, and a destination identification for specifying the Internet-protocol phone terminal as a communication destination are associated with one another.

### BRIEF DESCRIPTION OF THE DRAWINGS

FIG. 1 is an example in which calls need to be transferred according to availabilities of IP phone terminals;

FIG. 2 is an example of operational states in which a call cannot be received or reception of a call is undesirable;

FIG. 3 is a block diagram of a configuration of a communication system according to an embodiment of the present invention;

FIG. 4 is a block diagram of an IP phone terminal;

FIG. 5 is a block diagram of an authenticating apparatus;

FIG. 6 is an example of a data configuration of state information stored in a state storage unit;

FIG. 7 is an example of a data configuration of order information stored in an order-information storage unit;

FIG. 8 is an example of a data configuration of information stored in a numerical-value storage unit;

FIG. 9 is a block diagram of an IP phone server;

FIG. 10 is a sequence diagram of a general flow of an information notifying process according to the embodiment; and

FIG. 11 is a schematic diagram for explaining a hardware configuration of the authenticating apparatus according to the embodiment.

### DETAILED DESCRIPTION OF THE INVENTION

Exemplary embodiments of the present invention will be explained below in detail with reference to the accompanying drawings.

When a softphone is used, there are conventionally such problems that (1) when a call is issued to an inaccessible terminal (a terminal that is not connected to a network, is suspended, is powered off, or the like), no response is returned, and therefore a communication cannot be established, and (2) when the CPU processing load is high, a call can be issued; however, an actual quality of speech can be low and thus impractical. In these cases, a telephone number of another neighboring terminal needs to be checked to issue another call thereto. Therefore, a person who issues a call requires longer time until a communication is started.

In the conventional method, transfer destinations cannot be switched according to specific uses of the PCs. For example, the conventional method cannot address the following demands. (1) When a user A does not want an interruption by a softphone into an operation screen of a notebook PC while working on the PC, calls to the user A are to be transferred to a fixed IP phone terminal that is allocated to a desk of the user A, (2) when the PC of the user A is in a state where a screen-saver is activated, calls to the user A are to be not received by the softphone of the PC but transferred to the fixed IP phone terminal allocated to the desk of the user A, and (3) when the PC of the user A is in a state where the CPU is busy, calls to the user A are to be received by a softphone of another PC owned by the user A.

A communication system according to an embodiment of the present invention selects a more appropriate IP phone terminal from among plural IP phone terminals accessible to a user as a connection destination of a call, according to operational states of the IP phone terminals.

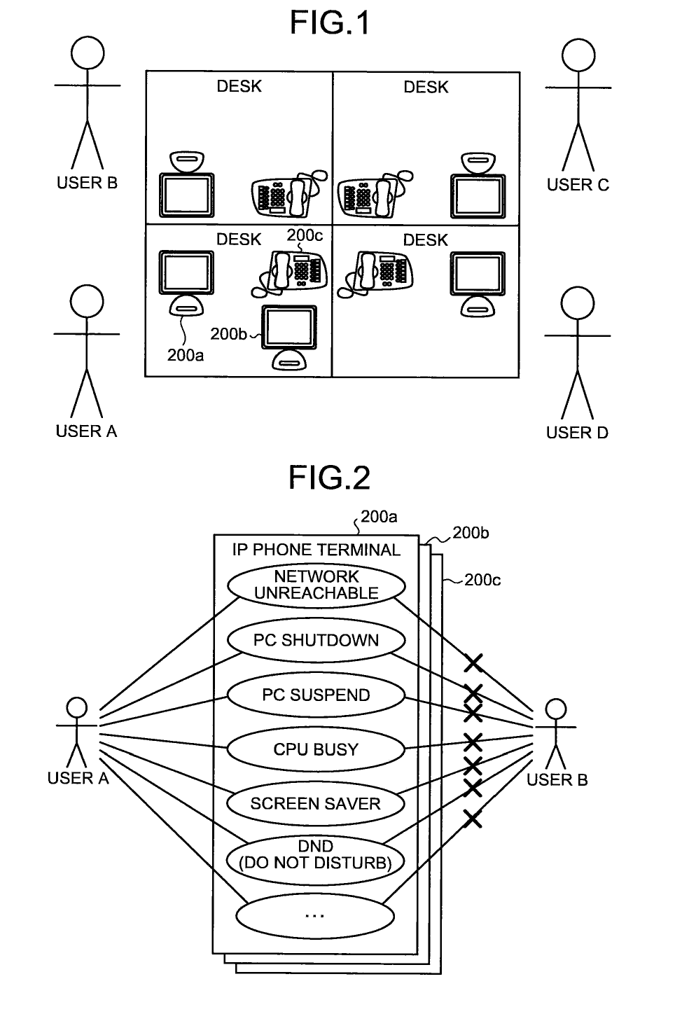

An example of a situation in which an appropriate IP phone terminal needs to be selected from among plural IP phone terminals is explained. FIG. 1 is an example in which one fixed phone and at least one PC are allocated to each of four users A to D. IP phone terminals 200a and 200b as PCs on which the softphone operates, and an IP phone terminal 200c as a fixed phone, that is, three IP phone terminals 200 in total are allocated to the user A.

It is assumed in this example that different phone numbers are assigned to the IP phone terminals of the user A, respectively. In this example, when the IP phone terminal 200a is in a busy state for example, it is desirable that a call specifying the phone number of the IP phone terminal 200a be transferred to another terminal of the user A, that is, the IP phone terminal 200b or 200c. The communication system according to the present embodiment can achieve this transfer by switching transfer destinations according to operational states of the IP phone terminals 200.

An example of an operational state in which transfer of a call should be avoided is explained next. FIG. 2 is an example in which the user A has the plural IP phone terminals 200a to 200c like in FIG. 1, and the user B calls the user A.

As shown in FIG. 2, a call cannot be established in operational states such as states in which the PC is disconnected from a network (Network Unreachable), and the PC is powered off (PC shutdown). Reception of a call is undesirable in operational states such as states in which the PC is suspended (PC suspend), the CPU is busy (CPU busy), and the screen saver is activated (Screen Saver), and a DND (Do Not Disturb) state. The DND state is a state in which a user expressly specifies refusal of transfer of calls.

These states suggest that transfer of calls to one of the IP phone terminals 200 is undesirable; however, the calls can be transferred to other IP phone terminals 200.

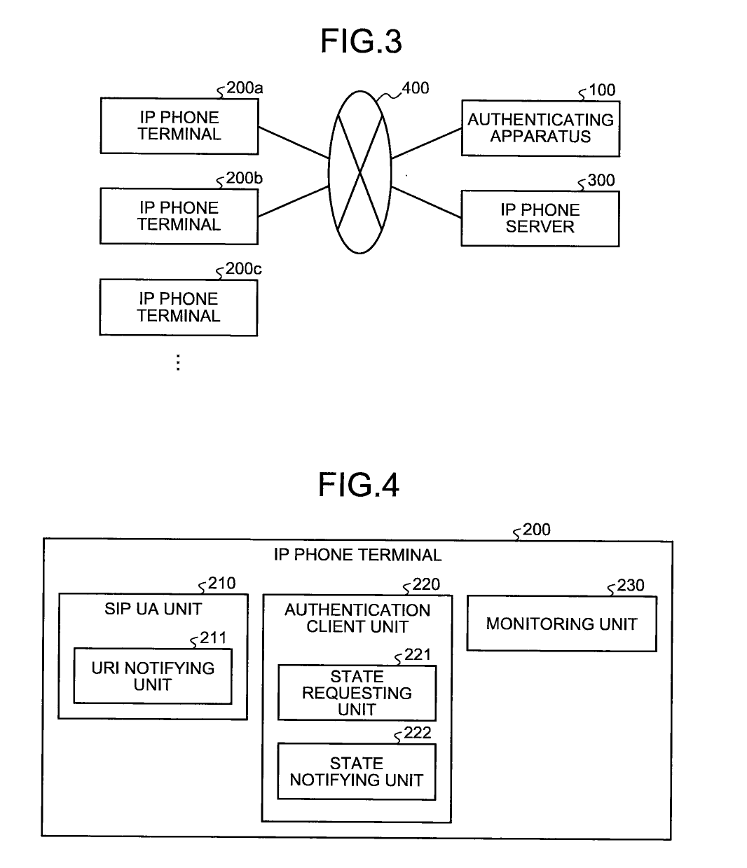

A configuration of the communication system according to the present embodiment is explained. As shown in FIG. 3, the communication system according to this embodiment includes the plural IP phone terminals 200a to 200c, an authenticating apparatus 100, and an IP phone server 300, which are connected via a network 400 such as the Internet.

The IP phone terminals 200a to 200c each implement an IP phone function by using a session initiation protocol (SIP) or the like. The IP phone terminals 200a to 200c can be realized as a softphone operating on a PC or a fixed IP phone, as described above. Because the IP phone terminals 200a to 200c have the same function, the IP phone terminals 200a to 200c may be hereinafter referred to simply as “IP phone terminals 200”. The number of the IP phone terminals 200 is not limited to three as shown in FIG. 3.

The authenticating apparatus 100 authenticates users of the IP phone terminals 200, and stores therein operational states of the IP phone terminals 200 used by the authenticated users, with respect to each user. The authenticating apparatus 100 determines the order of priority in which a call to a user is relayed, according to the operational states, and notifies the IP phone server 300 of information about the determined order of priority.

The authenticating apparatus 100 can be connected to an external authenticating server (not shown) that manages authentication information to be used for authentication and performs requested authentication of a user by using the authentication information, via the network 400. In this case, the authenticating apparatus 100 can authenticate a user by means of the authenticating server.

The IP phone server 300 is an apparatus that realizes an IP phone system by relaying calls between the IP phone terminals 200 using the SIP or the like. For example, the IP phone server 300 has a function as an SIP redirect server that determines a relay destination of a call, and a function of an SIP proxy server that transfers a call to the determined relay destination. These functions can be implemented on physically separate servers.

A detailed configuration of the IP phone terminal 200 is explained with reference to FIG. 4. As shown in FIG. 4, the IP phone terminal 200 includes an SIP user agent (UA) unit 210, an authentication client unit 220, and a monitoring unit 230.

The SIP UA unit 210 implements a function as an SIP terminal. The SIP UA unit 210 includes a uniform resource identifier (URI) notifying unit 211. The URI notifying unit 211 notifies the authentication client unit 220 of an SIP URI of the terminal itself, managed in the SIP UA unit 210.

The authentication client unit 220 implements a function as an authentication client for which network authentication is performed by the authenticating apparatus 100. For example, the authentication client unit 220 has a function of transmitting a user ID inputted by a user or previously stored to the authenticating apparatus 100, and receiving an authentication result from the authenticating apparatus 100. The authentication client unit 220 includes a state requesting unit 221, and a state notifying unit 222.

The state requesting unit 221 requests the monitoring unit 230 to obtain a current operational state of the terminal. The state notifying unit 222 notifies the current operational state obtained from the monitoring unit 230 to the authenticating apparatus 100. More specifically, the state notifying unit 222 notifies state information to the authenticating apparatus 100, the state information including the obtained operational state, the user ID of the authenticated user, and the SIP URI of the terminal, which are related to each other. In this way, the authenticating apparatus 100 that receives the notification can manage the operational states of the IP phone terminals 200 with respect to each user.

The monitoring unit 230 obtains the operational state of the terminal in response to the request from the state requesting unit 221, and sends the operational state back to the requesting source. The monitoring unit 230 monitors the operational state to check, for example, whether the terminal is connected to the network, the power is turned on or off, the terminal is suspended, the terminal is in a CPU-busy state, the screen saver is activated, and the terminal is in a DND state. Examples of the operational states are not limited to those above mentioned.

The monitoring unit 230 can periodically monitor the operational state and notify the authentication client unit 220 of the operational state at specified time intervals. Alternatively, the monitoring unit 230 can notify the authentication client unit 220 of the monitored operational state when the monitored operational state meets given criteria. For example, the monitoring unit 230 can be adapted to notify the authentication client unit 220 that the terminal is in a CPU-busy state when a monitored CPU utilization exceeds a predetermined threshold.

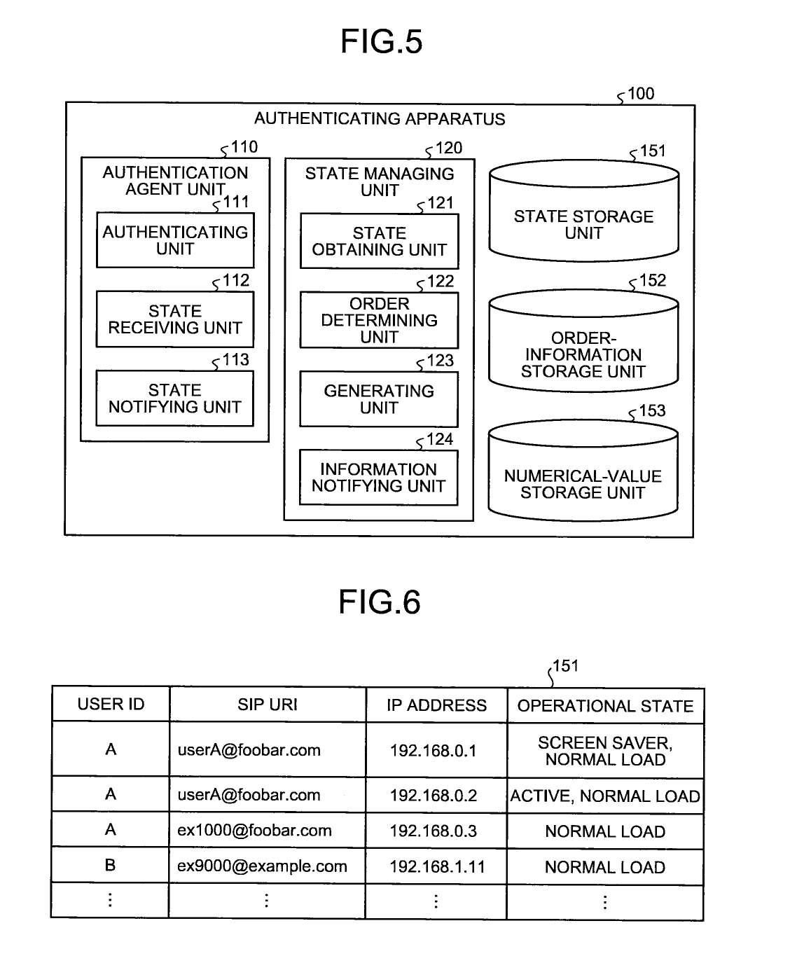

A detailed configuration of the authenticating apparatus 100 is explained next with reference to FIG. 5. As shown in FIG. 5, the authenticating apparatus 100 includes a state storage unit 151, an order-information storage unit 152, a numerical-value storage unit 153, an authentication agent unit 110, and a state managing unit 120.

The state storage unit 151 stores therein the state information received from the IP phone terminal 200. As shown in FIG. 6, the state information includes the user ID, the SIP URI, an IP address, and the operational state.

FIG. 6 includes an example of the state information of a case in which the user A having a user ID=A owns IP phone terminals 200 as softphones having the same SIP URI “userA@foobar.com” and operating on two PCs, and the IP phone terminal 200 as a fixed phone having an SIP URI “ex1000@foobar.com”.

As shown in FIG. 6, the same SIP URI can be assigned to plural IP phone terminals 200. In this case, the state information contains an IP address related thereto, thereby to identify the terminal. Plural operational states can be specified in a column of the operational state. FIG. 6 indicates that operational states of the IP phone terminal 200 having the SIP URI=“userA@foobar.com” and the IP address=“192.168.0.1” are a screen-saver activated state and a normal load state, for example.

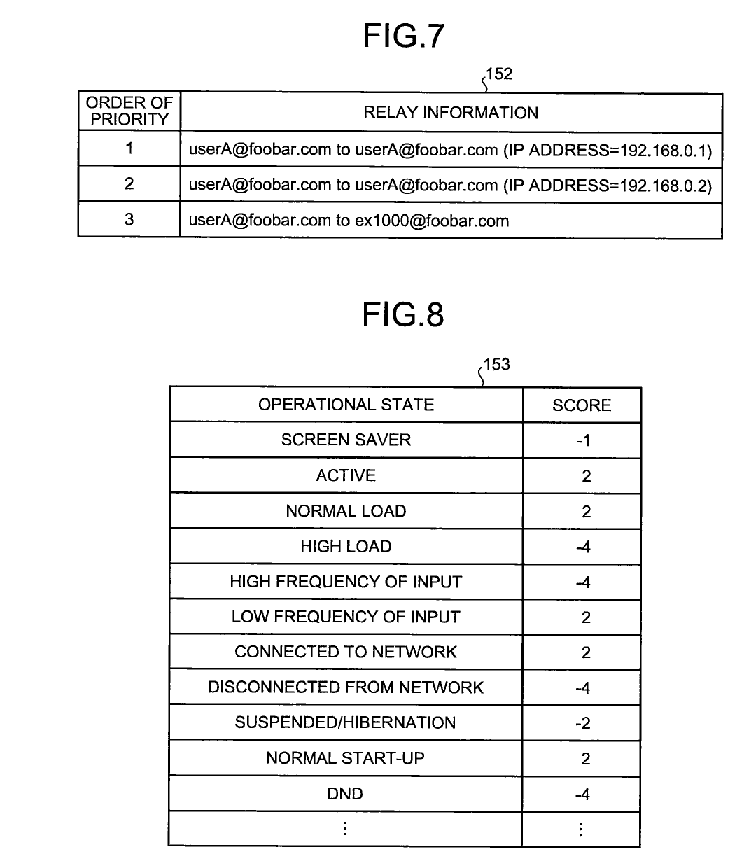

Returning to FIG. 5, the order-information storage unit 152 stores therein order information indicating that a call is relayed in an order determined by an order determining unit 122 (described later) in the state managing unit 120. As shown in FIG. 7, the order information includes a priority and relay information represented in the form of “(SIP URI 1) to (SIP URI 2)”. The relay information indicates that a call to “SIP URI 1” is transferred to “SIP URI 2” as a relay destination. The order information shown in FIG. 7 indicates that the relay information is selected in the order of priority to obtain “SIP URI 2” as the relay destination. When the same SIP URI is assigned to the IP phone terminals 200, the IP addresses can be included in the relay information to enable to identify the IP phone terminals 200, as shown in FIG. 7.

Returning to FIG. 5, the numerical-value storage unit 153 stores therein numerical values (hereinafter, “scores”) previously determined according to types of the operational states. The score is used by the order determining unit 122 (described later) to determine the order information indicating that a call is transferred to an appropriate relay destination according to the operational states. That is, as the score, a smaller value is set for an operational state with a higher processing load according to the processing load of the IP phone terminal 200 in each operational state, for example. In this way, the order determining unit 122 can determine the order in such a manner that a lower order is set to the IP phone terminal 200 having a higher score, for example.

As shown in FIG. 8, the numerical-value storage unit 153 stores therein information of a score related to each operational state. The type of the operational state monitored by the monitoring unit 230 is set as the operational state. For example, whether the terminal is in a screen-saver activated state, an active state not indicating the screen-saver activated state, a normal load state, or a high load state, user inputs occur with high frequency or low frequency, the terminal is connected to or disconnected from a network, the terminal is in a suspended/hibernation state, a normal startup state not indicating the suspended/hibernation state, or the (Do Not Disturb)DND state can be set as the operational states. As shown in FIG. 8, a negative value can be set as the score.

Returning to FIG. 5, the authentication agent unit 110 includes an authenticating unit 111 that receives a network authentication request from the IP phone terminal 200, and authenticates the IP phone terminal. More specifically, the authenticating unit 111 receives a user ID from the IP phone terminal 200, and authenticates the user using the received user ID. As an authentication protocol, any protocol commonly used such as a protocol for carrying authentication for network access (PANA) can be applied. By authenticating the user using the PANA or the like, a communication with high reliability can be established between the IP phone terminal 200 and the authenticating apparatus 100.

The authentication agent unit 110 further includes a state receiving unit 112, and a state notifying unit 113.

The state receiving unit 112 receives the state information notified by the state notifying unit 222 of the IP phone terminal 200, and stores the received state information in the state storage unit 151. The state notifying unit 113 notifies the state managing unit 120 of the received state information.

The state managing unit 120 manages the state information received from each IP phone terminal 200. The state managing unit 120 includes a state obtaining unit 121, the order determining unit 122, a generating unit 123, and an information notifying unit 124.

The state obtaining unit 121 receives the state information notified by the state notifying unit 113, and obtains from the state storage unit 151, the state information including the same user ID as the user ID included in the received state information.

The order determining unit 122 refers to the operational states included in the obtained state information, and determines the order of priority of the IP phone terminals 200 to which a call to a user having the user ID included in the obtained state information is relayed, according to a rule previously determined. More specifically, when the state obtaining unit 121 obtains plural pieces of the state information including the same user ID, the order determining unit 122 first obtains from the numerical-value storage unit 153, a score corresponding to the operational states included in each of the state information. The order determining unit 122 determines the order in such a manner that the IP phone terminal 200 having an SIP URI corresponding to an operational state with a higher score is given a higher priority. When plural operational states are specified, a sum of scores corresponding to the operational states is calculated, and used for comparison with scores (or sums of scores) of other operational states.

The generating unit 123 generates order information as shown in FIG. 7, indicating that a call is relayed in the determined order, and stores the generated order information in the order-information storage unit 152. The generating unit 123 generates the order information in the same form as that of the order information that can be used by the IP phone server 300. In this way, the IP phone server 300 just needs to be adapted to use the order information received from the authenticating apparatus 100.

The information notifying unit 124 notifies the IP phone server 300 of the generated order information.

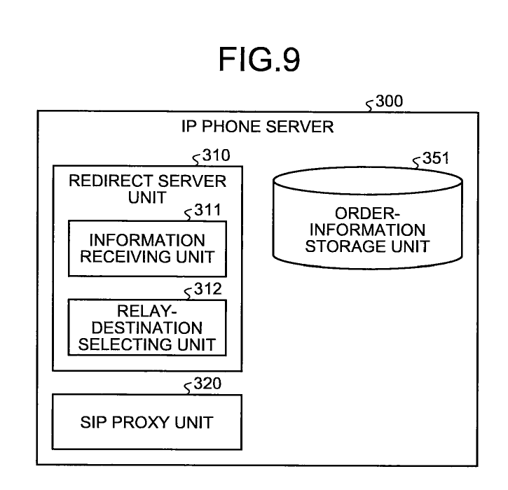

A detailed configuration of the IP phone server 300 is explained with reference to FIG. 9. As shown in FIG. 9, the IP phone server 300 includes an order-information storage unit 351, a redirect server unit 310, and an SIP proxy unit 320.

The order-information storage unit 351 stores therein the order information notified by the authenticating apparatus 100. A data configuration of the order information stored in the order-information storage unit 351 is the same as that of the order information stored in the order-information storage unit 152 of the authenticating apparatus 100, and therefore explanations thereof are omitted.

The redirect server unit 310 implements a function as an SIP redirect server, and includes an information receiving unit 311 and a relay-destination selecting unit 312.

The information receiving unit 311 receives the order information from the authenticating apparatus 100, and stores the received order information in the order-information storage unit 351.

The relay-destination selecting unit 312 selects a relay destination of a call addressed to an SIP URI according to the order of priority in the order information. For example, in the case of the order information as shown in FIG. 7, the relay-destination selecting unit 312 first selects the IP phone terminal 200 having the SIP URI =“userA@foobar.com (IP address=192.168.0.1)” as an IP phone terminal 200 used for the relay destination of the call, based on the relay information having the order of priority=1. When a communication with the selected IP phone terminal 200 cannot be established, the relay-destination selecting unit 312 selects a relay destination specified by the relay information of the second highest priority.

The SIP proxy unit 320 implements a function as an SIP proxy server. For example, the SIP proxy unit 320 has a function of relaying a call addressed to an SIP URI to a relay destination selected by the relay-destination selecting unit 312.

The state storage unit 151, the order-information storage unit 152, and the numerical-value storage unit 153 of the authenticating apparatus 100, and the order-information storage unit 351 of the IP phone server 300 can be any storage medium commonly used, such as a hard disk drive (HDD), an optical disk, a memory card, and a random access memory (RAM).

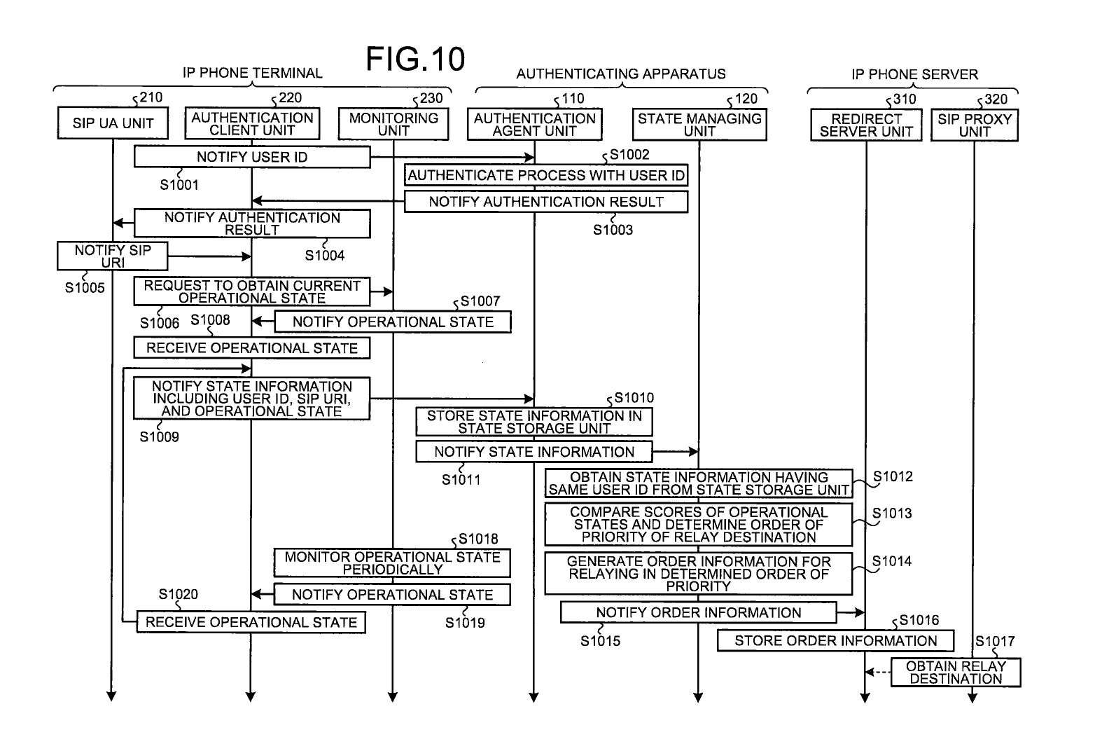

An information notifying process performed by the communication system thus configured according to the present embodiment is explained next with reference to FIG. 10. The information notifying process is performed by the authenticating apparatus 100 for determining the order of priority of relay destinations by referring to the operational states received from the IP phone terminals 200, and notifying the IP phone server 300 of the order information indicating the determined order of priority.

The authentication client unit 220 of the IP phone terminal 200 first notifies the authentication agent unit 110 of the authenticating apparatus 100 of the user ID of the user, to start network authentication (Step S1001).

The authentication agent unit 110 of the authenticating apparatus 100 receives the notification, and executes a network authenticating process with the user ID by means of the authenticating unit 111 (Step S1002). The authenticating unit 111 then notifies the IP phone terminal 200 of a result of the authentication (Step S1003). When the authentication is successful, the authentication client unit 220 of the IP phone terminal 200 notifies the SIP UA unit 210 of the successful authentication (Step S1004).

The URI notifying unit 211 of the SIP UA unit 210 that receives the notification of the successful authentication notifies the authentication client unit 220 of an SIP URI used by the IP phone terminal 200 (Step S1005). The authentication client unit 220 holds the notified SIP URI to use the SIP URI in notification of state information.

The state requesting unit 221 of the authentication client unit 220 then requests the monitoring unit 230 to obtain a current operational state of the IP phone terminal 200 (Step S1006). The monitoring unit 230 obtains the current operational state, and notifies the authentication client unit 220 as the requesting source of the obtained current operational state (Step S1007). The authentication client unit 220 receives the notified operational state (Step S1008).

The state notifying unit 222 of the authentication client unit 220 then notifies the authenticating apparatus 100 of the state information including the user ID of the authenticated user, the SIP URI notified from the SIP UA unit 210 and held therein, and the notified operational state (Step S1009).

The authentication agent unit 110 of the authenticating apparatus 100 receives the state information by means of the state receiving unit 112, and stores the received state information in the state storage unit 151 (Step S1010). The state notifying unit 113 then notifies the state managing unit 120 of the received state information (Step S1011).

The state obtaining unit 121 of the state managing unit 120 obtains from the state storage unit 151, state information including the same user ID as the user ID included in the notified state information (Step S1012). The order determining unit 122 then compares scores of the operational states included in the obtained state information with each other, and determines the order of priority of relay destinations (Step S1013). The order determining unit 122 obtains the scores of the operational states from the numerical-value storage unit 153.

The generating unit 123 then generates order information used in relaying a call in the determined order, and stores the generated order information in the order-information storage unit 152 (Step S1014). The information notifying unit 124 notifies the IP phone server 300 of the generated order information (Step S1015).

The IP phone server 300 receives the order information by means of the information receiving unit 311 of the redirect server unit 310, and stores the received order information in the order-information storage unit 351 (Step S1016). When relay of a call is requested then, the SIP proxy unit 320 inquires of the redirect server unit 310, thereby obtaining an SIP URI of the IP phone terminal 200 to be a relay destination (Step S1017), and relays the call to the obtained SIP URI.

As described above, the effect according to the present embodiment can be achieved when other users make a call after the sequence is completed. More specifically, according to this embodiment, the order of priority of relay destinations is determined according to the operational states of the IP phone terminals 200 used by counterpart users. The order information for relaying a call in the order of priority can be registered in the IP phone server 300 before other users make a call. Accordingly, when other users make a call, the call can be transferred to the IP phone terminal 200 that is highly convenient for a user receiving the call, instead of the IP phone terminal 200 to which the call is to be originally transferred.

The monitoring unit 230 obtains the operational states of the IP phone terminals 200 periodically or when a certain event previously registered occurs (Step S1018), and notifies the authentication client unit 220 of the obtained operational states (Step S1019).

The authentication client unit 220 successively receives the notified operational states (Step S1020), and notifies the authenticating apparatus 100 of the state information upon each reception of the operational states (Step S1009). In this way, the authenticating apparatus 100 can obtain and manage the latest operational states of the IP phone terminals 200.

In FIG. 10, only one IP phone terminal 200 is described; however, the operational states of all IP phone terminals 200 that are owned by plural users, respectively, are obtained according to the sequence as shown in FIG. 10, and managed by the authenticating apparatus 100.

A specific example of the process of determining the order of priority, performed by the order determining unit 122, is explained. It is assumed below that the user A to whom a call is issued owns any of the IP phone terminals 200 of a softphone 1 operating on a notebook PC 1, a softphone 2 operating on a notebook PC 2, and a fixed phone 1. SIP URIs of the softphone 1, the softphone 2, and the fixed phone 1 are “userA@foobar.com”, “userA@foobar.com”, and “ex1000@foobar.com”, respectively. The user A applies the notebook PC 1 mainly for office automation (OA) purposes, and the notebook PC 2 mainly for development, for example.

### FIRST EXAMPLE

The notebook PCs 1 and 2 are provided on a desk of the user A, and successfully authenticated. The user A creates a program on the notebook PC 2. A screen saver is activated on the notebook PC 1, and a password needs to be inputted to the notebook PC 1 to deactivate the screen saver.

In this state, with respect to the notebook PC 1, the monitoring unit 230 notifies the authentication client unit 220 that the operational states thereof are a screen-saver activated state and a normal load state, for example (Step S1007 or S1019). The operational states are finally notified the state managing unit 120 of the authenticating apparatus 100 (Step S1011).

Meanwhile, with respect to the notebook PC 2, the monitoring unit 230 notifies the authentication client unit 220 that the operational states thereof are a state in which there are inputs through a keyboard now (active state) and a normal load state, for example (Step S1007 or S1019). The operational states are finally notified the state managing unit 120 of the authenticating apparatus 100 (Step S1011).

As a result, the authenticating apparatus 100 stores the operational states of the notebook PCs 1 and 2 in the state storage unit 151, with respect to the user A.

Meanwhile, in the order determining unit 122 of the state managing unit 120, a rule of “giving priority to a terminal in an active state over a terminal in a screen-saver activated state” is previously set. This rule can be realized by assigning scores to the operational states as shown in FIG. 8. FIG. 8 is an example in which a score of the screen-saver activated state is set at “−1”, a score of the active state is set at “2”, and a score of the normal load state is set at “2”.

In this example, a total score of the operational states of the notebook PC 1 is “1”, and a total score of the operational states of the notebook PC 2 is “4”. Therefore, the notebook PC 2 is given priority as the relay destination. Therefore, when the user B calls the user A by addressing the SIP URI=“userA@foobar.com” for example, the SIP proxy unit 320 of the IP phone server 300 is set to ring the notebook PC 2 and the notebook PC 1 in this order.

### SECOND EXAMPLE

The notebook PCs 1 and 2 are provided on the desk of the user A, and successfully authenticated. The user A performs an operation of building a program on the notebook PC 2 in which a load of the CPU is relatively high. Meanwhile, the notebook PC 1 is in the normal load state.

In this example, the authenticating apparatus 100 stores the operational states of the notebook PCs 1 and 2 as the normal load state and the high load state, respectively, in the state storage unit 151.

In the order determining unit 122 of the state managing unit 120, a rule of “giving priority to a terminal in the normal load state over a terminal in the high load state” is previously set. Like in the first example, this rule can be realized by assigning scores to the operational states as shown in FIG. 8. FIG. 8 depicts the example in which the score of the normal load state is set at “2”, and a score of the high load state is set at “−4”.

In this example, a total score of the operational state of the notebook PC 1 is “2”, and a total score of the operational state of the notebook PC 2 is “−4”. Therefore, the notebook PC 1 is given priority as the relay destination.

A rule that “a terminal having a negative score receives no call” can be applied. In this example, because the notebook CP 2 has a negative score (−4), the notebook PC 2 is set to receive no call. More specifically, the generating unit 123 generates the order information not including the relay information as to the notebook PC 2. As a result, when the user B calls the user A by addressing the SIP URI=“userA@foobar.com” for example, the SIP proxy unit 320 of the IP phone server 300 is set to ring only the notebook PC 1.

The assignment of the scores can be properly changed according to environments to which the communication system is applied. When the rule that a terminal having a negative score receives no call is applied for example, a situation in which some PCs receive no call may occur depending on how the scores are assigned. It is desirable that the operator of the system previously design proper scores to avoid such a situation.

### THIRD EXAMPLE

The notebook PCs 1 and 2 are provided on the desk of the user A, and successfully authenticated. The user A performs an operation of building a program on the notebook PC 2, in which a load of the CPU is relatively high. Meanwhile, a screen saver is activated on the notebook PC 1, and a password needs to be inputted to the notebook PC 1 to deactivate the screen saver.

In this example, the authenticating apparatus 100 stores operational states of the notebook PCs 1 and 2 as the normal load state and the screen-saver activated state, and the high load state and the active state, respectively, in the state storage unit 151.

When the scores as shown in FIG. 8 are set, a total score of the operational states of the notebook PC 1 is “1(=−1+2)”, and a total score of the operational states of the notebook PC 2 is “−2(=2+(−4))” in this example. Therefore, the notebook PC 1 is given priority as the relay destination.

As a result, when the user B calls the user A by addressing the SIP URI =“userA@foobar.com” for example, the SIP proxy unit 320 of the IP phone server 300 is set to ring the notebook PC 1 and the notebook PC 2 in this order. When the rule of not relaying a call to a terminal having a negative score is applied, the SIP proxy unit 320 is set to ring only the notebook PC 1.

### FOURTH EXAMPLE

The notebook PCs 1 and 2, and the fixed phone 1 are provided on the desk of the user A, and all successfully authenticated. The user A is reading a paper document, and thus screen savers are activated on the notebook PCs 1 and 2. Passwords need to be inputted to the notebook PCs to deactivate the screen savers.

In this example, the authenticating apparatus 100 stores operational states of the notebook PCs 1 and 2 both as the normal load state and the screen-saver activated state, in the state storage unit 151. The authenticating apparatus 100 stores an operational state of the fixed phone 1 as the normal load state in the state storage unit 151.

When a score of the screen-saver activated state is set at “−1”, and a score of the normal load state is set at “0” in the numerical-value storage unit 153, a total score of the operational state of each of the notebook PCs 1 and 2 is “−1(=0+(−1))”, and a score of the operational state of the fixed phone 1 is “0” in this example. Accordingly, the fixed phone 1 is given priority over the notebook PCs 1 and 2, and set as the relay destination.

As a result, when the user B calls the user A by addressing the SIP URI=“userA@foobar.com” for example, the SIP proxy unit 320 of the IP phone server 300 is set to transfer the call addressed to “userA@foobar.com” to the SIP URI (ex1000@foobar.com) of the fixed phone 1 that is also authenticated for the user A. This is because the notebook PCs 1 and 2 are both in the operational state in which a call should not been issued thereto.

As described above, the communication system according to the present embodiment can collect the operational states of the IP phone terminals by means of the authenticating apparatus that authenticates the IP phone terminals, determine the order of priority of the IP phone terminals that are to be selected as the relay destination, and notify the IP phone server of the order of priority. Accordingly, the communication system can select a more appropriate IP phone terminal as a connection destination of a call from among plural IP phone terminals available to a user, according to the operational states of the IP phone terminals.

In the present embodiment, the authenticating apparatus collects the operational states. However, the IP phone terminals can directly notify the IP phone server of their operational states. In such a case, the IP phone server can determine the order of priority according to the notified operational states. However, when the operational states are notified the authenticating apparatus, the operational states can be notified using highly reliable communications between the IP phone terminals and the authenticating apparatus. Therefore, decrease in security due to fraudulent changes of the operational states, or the like, can be avoided. When the authenticating apparatus determines the order of priority and notifies the IP phone server of the order of priority, it is advantageous in that the need to alter the IP phone server implementing a standard protocol such as the SIP is reduced.

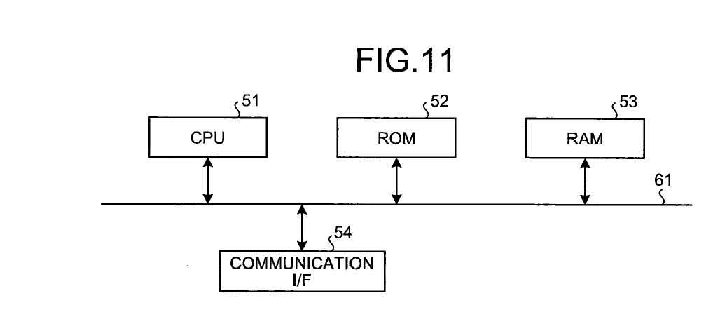

A hardware configuration of the authenticating apparatus according to the present embodiment is explained with reference to FIG. 11.

The authenticating apparatus according to this embodiment includes a controller such as a CPU 51, storage devices such as a read only memory (ROM) 52 and a random access memory (RAM) 53, a communication interface (I/F) 54 that connects to a network to establish communications, an external storage device such as a HDD and a compact disk (CD) drive, a display apparatus such as a display, an input device such as a keyboard and a mouse, and a bus 61 that connects these components. The hardware configuration is realized by using a normal computer.

An information notifying program performed by the authenticating apparatus according to the present embodiment is provided being recorded in a computer-readable storage medium such as a CD-ROM, a flexible disk (FD), a CD recordable (CD-R), a digital versatile disk (DVD), and the like, in a file of an installable or executable form.

The information notifying program performed by the authenticating apparatus according to the present embodiment can be stored in a computer connected to a network such as the Internet, and downloaded through the network. The information notifying program performed by the authenticating apparatus according to the present embodiment can be provided or distributed through a network such as the Internet.

The information notifying program according to the present embodiment can be previously installed in a ROM or the like.

The information notifying program performed by the authenticating apparatus according to the present embodiment has a module configuration including the components above mentioned (the authenticating agent unit and the storage managing unit). As practical hardware, the information notifying program is read from the storage medium and executed by the CPU 51 (processor), so that the components above mentioned are loaded into a main memory and generated on the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication system in which a plurality of Internet-protocol phone terminals, an authenticating apparatus that authenticates users of the Internet-protocol phone terminals, and a server device that relays a communication between the Internet-protocol phone terminals are connected with one another via a network, comprising:
each of the Internet-protocol phone terminals includes
a monitoring unit that monitors operational state of the Internet-protocol phone terminal, and
a state notifying unit that notifies state information to the authenticating apparatus, the state information including the operational state, a user identification for identifying a user authenticated by the authenticating apparatus, and a destination identification for specifying the Internet-protocol phone terminal as a communication destination, which are related to each other,
the authenticating apparatus includes
a state receiving unit that receives the state information from the Internet-protocol phone terminal,
a state storage unit that stores therein the state information,
an authenticating unit that authenticates the users,
a state obtaining unit that obtains the state information including a user identification same as a user identification included in received state information from the state storage unit,
an order determining unit that determines, when a plurality of pieces of state information is obtained, an order for selecting a second destination identification included in the state information as a destination identification to be used for a relay destination of a communication addressed to a first destination identification included in the state information, based on the operational state included in each of the pieces of state information,
a generating unit that generates order information indicating a selection of the second destination identification in the order determined by the order determining unit, and
an information notifying unit that notifies the order information to the server device, and
the server device includes
an information receiving unit that receives the order information from the authenticating apparatus, and
a relay-destination selecting unit that selects the second destination identification based on received order information.

2. An authenticating apparatus comprising:
a state receiving unit that receives a state information from the Internet-protocol phone terminals, the state information including an operational state, a user identification for identifying a user authenticated by an authenticating apparatus, and a destination identification for specifying an Internet-protocol phone terminal as a communication destination, which are related to each other;
a state storage unit that stores therein the state information
an authenticating unit that authenticates users of the Internet-protocol phone terminals;
and stores the state information in the state storage unit;
a state obtaining unit that obtains the state information including a user identification same as a user identification included in received state information from the state storage unit;
an order determining unit that determines, when a plurality of pieces of state information is obtained, an order for selecting a second destination identification included in the state information as a destination identification to be used for a relay destination of a communication addressed to a first destination identification included in the state information, based on the operational state included in each of the pieces of state information;
a generating unit that generates order information indicating a selection of the second destination identification in the order determined by the order determining unit; and
an information notifying unit that notifies the order information to the server device.

3. The authenticating apparatus according to claim 2, further comprising:
a numerical-value storage unit that stores therein the operational state and a predetermined numerical value according to the operational state in association with each other, wherein
the order determining unit determines an order of a second destination identification corresponding to an operational state having a larger numerical value lower than an order of a second destination identification corresponding to an operational state having a smaller numerical value.

4. The authenticating apparatus according to claim 3, wherein
the numerical value is smaller as a processing load of the Internet-protocol phone terminal is larger.

5. The authenticating apparatus according to claim 3, wherein
the operational state includes a rejection state in which the user specifies to reject a relay of a communication, and
the numerical value for the rejection state is smaller than the numerical values for operational states other than the rejection state.

6. The authenticating apparatus according to claim 3, wherein
the state information includes a plurality of operational states, and
when obtained state information includes a plurality of operational states, the order determining unit calculates a sum of the numerical values corresponding to the operational states, and determines an order of a second destination identification corresponding to the operational state having a larger sum or numerical value lower than an order of a second destination identification corresponding to the operational state having a smaller sum or numerical value.

7. The authenticating apparatus according to claim 3, wherein
the order determining unit determines the order with respect to second destination identifications having numerical values of corresponding operational states larger than a predetermined threshold.

8. The authenticating apparatus according to claim 2, wherein
the destination identifications are session initiation protocol uniform resource identifiers.

9. An Internet-protocol phone terminal configured to be connected to an authenticating apparatus that authenticates a user of the Internet-protocol phone terminal via a network, the Internet-protocol phone terminal comprising:
a monitoring unit that monitors operational state of the Internet-protocol phone terminal; and
a state notifying unit that notifies the authenticating apparatus of state information in which the operational state, a user identification for identifying a user authenticated by the authenticating apparatus, and a destination identification for specifying the Internet-protocol phone terminal as a communication destination are associated with one another.
